(19) United States
(12) Patent Application Publication
(10) Pub. No.: US 2009/0008162 A1
(43) Pub. Date: Jan. 8, 2009

(54) Input Device of Capacitive Touchpad

(76) Inventors: Wei-Wen Yang, Banciao City (TW); Chun-Hua Lin, Tucheng City (TW)

Correspondence Address: HDSL, P.O. BOX 220746, CHANTILLY, VA, 20153-0746, US

(21) Appl. No.: 12/017,472

(22) Filed: Jan. 22, 2008

Related U.S. Application Data
(60) Provisional application No. 60/947,945, filed on Jul. 3, 2007.

(51) Int. Cl. G06F 3/044

(52) U.S. Cl. 178/18.06

(57) ABSTRACT

An input device of capacitive touchpad is capable of generating an inducing capacitance through holding by a user. The claimed input device includes a pen nib which is made of/from an electric-conductive material, a pen body providing wider holding area for the user and a connect part for holding by the user. The pen nib and the connect part have an inlaying component in pairs such as mortise to lodged in or inset into each other. The pen nib may be made of/from an elastic or soft electric-conductive material which is made of/from a polyester compound doped or mixed with a metal powder or having metallic covering stuffed with the elastic or soft electric-conductive material for increasing the contact surface area. Accordingly, the present invention solves the available pad area shortening problem and the capacitance sensing variation result from the sweat of finger.

### BACKGROUND

The present invention relates to an input device, and more specifically, the present invention discloses the input device for operating a capacitive touchpad and generating an inducing capacitance through holding by a user.

There are different kinds of touchpads nowadays. For instance, a capacitive touchpad generates capacitance induction through touching a surface of the capacitive touchpad by finger. As shown in FIG. 1, the capacitive touchpad 12 has an initial capacitance C and a coupling capacitance ΔC before and be touched by a finger 11, and then the inducing capacitance (C+ΔC) indicating the operation in the capacitive touchpad. The coordinate processing unit 13 connecting to the capacitive touchpad 12 converts the inducing capacitance into the coordinate to an arithmetic unit 14, and then propagates to a motion unit 15 and a gesture unit 16. However, touching in finger of prior art not only restricts the input way, but also causes the problems such as the available pad area shortening, erroneous judgment of sensor resulted from limited pad area and the capacitance sensing variation resulted from the sweat of finger.

In addition, current input device of touchpad is dedicated for resistive or electromagnetic touchpad. It seems the invalid solutions of input way of capacitive touchpad since the pen-typed input device of resistive touchpad is made of/from insulating materials, and the one of electromagnetic touchpad needs the power such as a battery to generate an electromagnetic induction.

### BRIEF SUMMARY

It is therefore a primary objective of the present invention to provide an input device of a capacitive touchpad which is capable of operating a capacitive touchpad, and an input device for operating a touchpad. These input devices at least includes a pen nib which is made of/from an electric-conductive material for touching the capacitive touchpad and generating sufficient coupling capacitance and inducing capacitance in a surface of the capacitive touchpad. In addition, the claimed input device may be used for operating various kinds of touchpads.

According to one preferred embodiment of the present invention, an input device of capacitive touchpad which is capable of generating an inducing capacitance of the capacitive touchpad through holding by a user includes a pen nib which is made of/from an electric-conductive material and for touching the capacitive touchpad, a pen body which one end of it is connected or set to the pen nib and a connect part between the pen nib and the pen body for holding by the user and generating the inducing capacitance with the pen nib.

According to another preferred embodiment of the present invention, an input device for operating a touchpad includes a pen body for holding by a user and a replaceable pen nib which is connected or set to one end of the pen body. The replaceable pen nib is made of/from an electric-conductive material for generating an inducing capacitance if the touchpad is a capacitive touchpad.

In one the preferred embodiment of the present invention, all or parts of components of the claimed input device may be made of/from same or similar kind of electric-conductive material. In other embodiment, the pen body is made of/from an insulating material, and the connect part is made of/from an insulating material covered with conductive film. In addition, the pen nib and the connect part are separable and having an inlaying component in pairs such as mortise, lock or protruding part and concaving part in pairs with spiral for insetting or spiral into each other. Beside, the pen nib is made of/from an elastic or soft electric-conductive material which is made of/from a polyester compound doped or mixed with a metal powder for increasing the contact surface area.

Accordingly, the present invention provides a substitution for touching the capacitive touchpad in finger directly and a solution of the problems such as the available pad area shortening, erroneous judgment of sensor and the capacitance sensing variation resulted from the sweat of finger. More, the claimed input device may be used for operating various kinds of touchpads.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of capacitance induction process of an input device and a capacitive touchpad sensing system of the prior art.

FIG. 2A is a schematic diagram of an input device before operated of a prior art.

FIG. 2B is a schematic diagram of capacitance induction process of an input device of the present invention.

FIG. 3A is a schematic diagram of the structure of the input device of one embodiment of the present invention.

FIG. 3B is a schematic diagram of the structure of the input device of another embodiment of the present invention.

FIG. 3C is a sectional diagram of the input device and the inlaying component in pairs of one embodiment of the present invention.

FIG. 3D is a sectional diagram of the input device and the inlaying component in pairs of another embodiment of the present invention.

FIG. 3E is a sectional diagram of the input device and the inlaying component in pairs of yet another embodiment of the present invention.

FIG. 4 is a schematic diagram of the input device of the touchpad of the present invention.

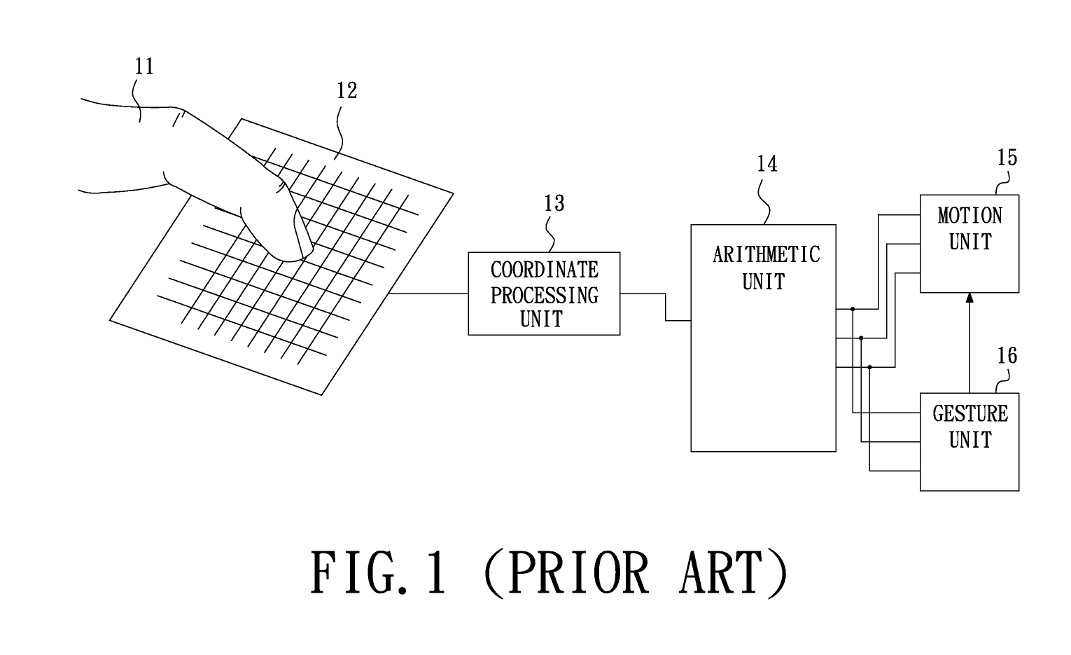

### DETAILED DESCRIPTION

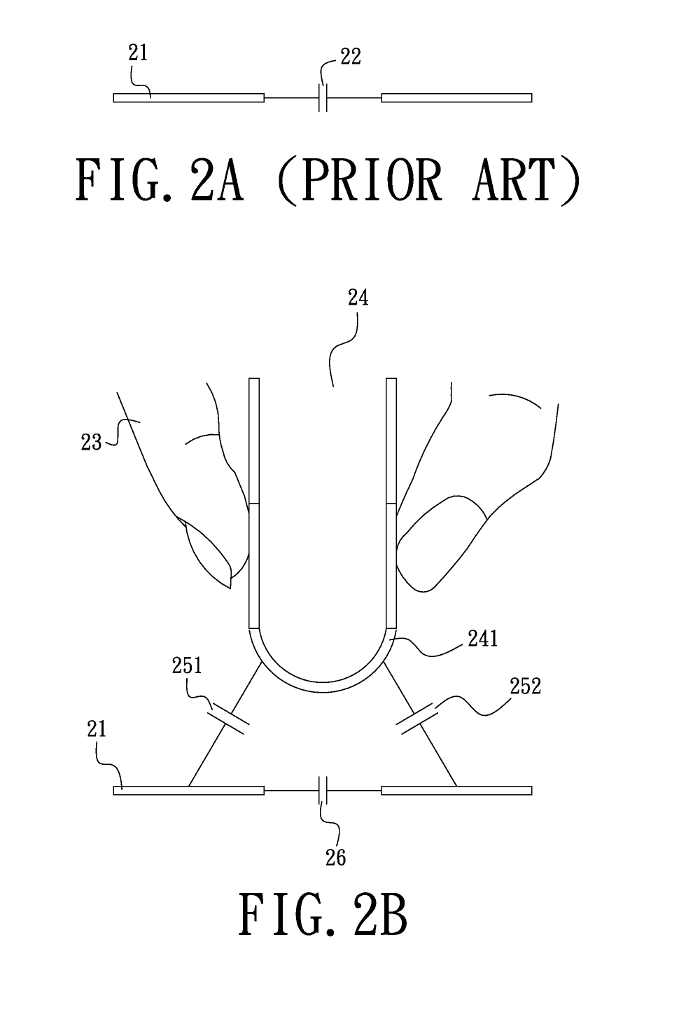

FIGS. 2A and 2B show an input device of a prior art before operated and a capacitance induction process of the input device of the present invention. A capacitive touchpad 21 has an initial capacitance 22 before any touch, and then the capacitive touchpad 21 generates the coupling capacitances 251 and 252 when the capacitive touchpad 21 is touched using a pen nib 241 of input device 24 held by finger 23 of a user's hand. Therefore, the inducing capacitance 26 is the sum of coupling capacitance 22 and initial capacitance 251 or 252.

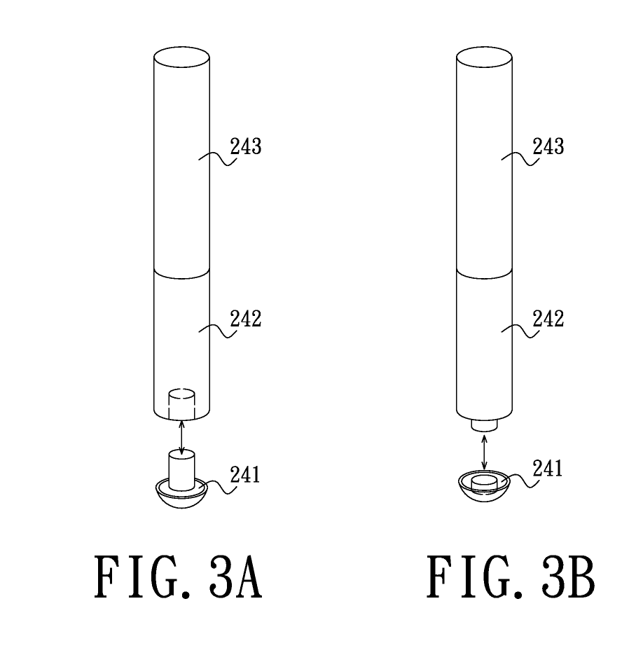

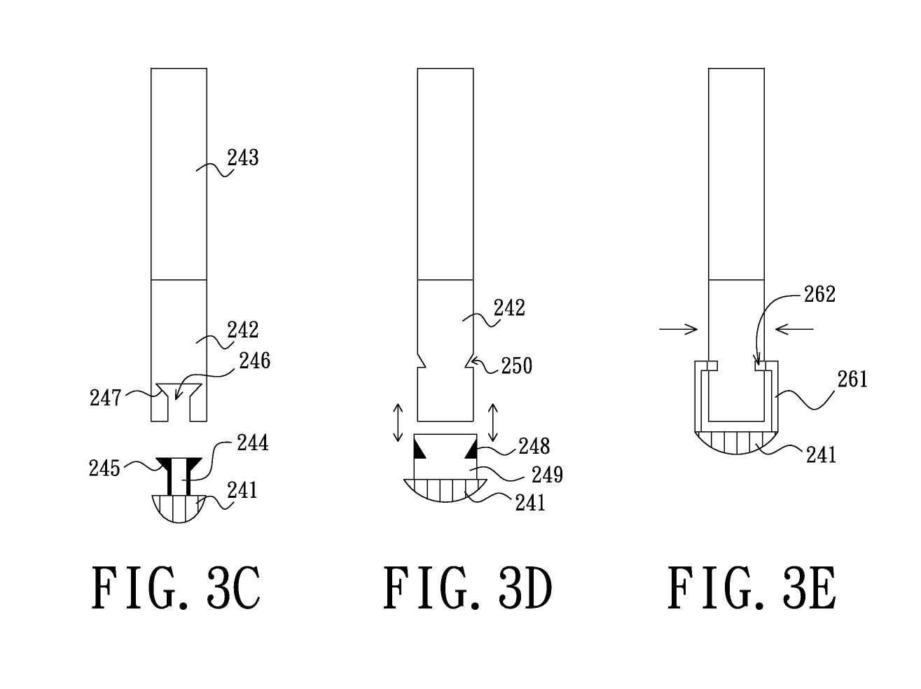

FIGS. 3A and 3B show various structure of the input device and the pen nib of the present invention. The input device 24 includes the pen nib 241, connect part 242 and pen body 243. The pen nib 241 is made of/from an electric-conductive material, and one end of it is connected or set to the pen body 243. The connect part 242 between the pen nib 241 and the pen body 243 for holding by the user and generating the inducing capacitance with the pen nib 241. Again, as shown in the FIGS. 3A and 3B, the pen nib 241 and the connect part 242 have an inlaying component in pairs for insetting into each other. More, a protruding part of the pen nib 241 insets into a concaving part of the connect part 242 in the FIG. 3A, and a concaving part of the pen nib 241 insets into a protruding part of the connect part 242 in the FIG. 3B.

Moreover, there are many choices for the materials of the pen nib 241, connect part 242 and pen body 243. It may use the same or similar kind of electric-conductive material for them all, and the pen nib 241 and the connect part 242 may be made of/from the electric-conductive materials such as a first metallic electric-conductive material differing from that such as wood belonging to a kind of insulating material of the pen body 243. In another embodiment, the pen nib 241 and the connect part 242 may be made of/from the first and a second metallic electric-conductive material respectively. Yet in another preferred embodiment, the pen nib 241 and the connect part 242 may be made of/from the first and the second metallic electric-conductive material respectively, and the connect part 242 may be made of/from the insulating material covered with electric-conductive film. Besides, user can either hold the pen nib 241 or the connect part 242 for their convenience and preference. However, the way that holding the connect part 242 only apply to the connect part 242 which is made of/from the insulating materials covered with electric-conductive film.

Again, for the sake of cleaning and looking, the pen nib 241 and the connect part 242 are separable and having an inlaying component in pairs such as mortise to inset into each other for replacement. As shown in the FIG. 3C, the pen nib 241 has a protruding part 244 for insetting into a concaving part 246 of the connect part 242, and the protruding part 244 has a retractable mortising component 245 which is shorten and spread to fix on a concave 247 while insetting into the concaving part 246. In another embodiment, as shown in the FIG. 3D, the protruding part 249 is hollow and having a retractable mortising component 248 which may inset into the connect part 242 having a concave 250.

In another preferred embodiment, the pen nib 241 and the connect part 242 with the protruding part and the concaving part may further have the spiral in pairs for spiraling or have the fixed mechanism in pairs such as a lock and a mortising component in pairs for integrating and separating. As shown in the FIG. 3E, the inlaying component in pairs of the pen nib 241 and the connect part 242 includes a mortising component 261 such as an elastic metal slice spread upwardly and integrated to a corresponding mortising component 262 for integrating the pen nib 241.

The pen nib of the present invention may be fully or either made of/from metallic covering stuffed with polyester compound or elastic or soft polyester compound doped or mixed with metal powder for flattening and then increasing the contact surface area once the pen nib contacted the capacitive touchpad. Therefore, the pen nib will adapt to the pressure and deformable temporarily.

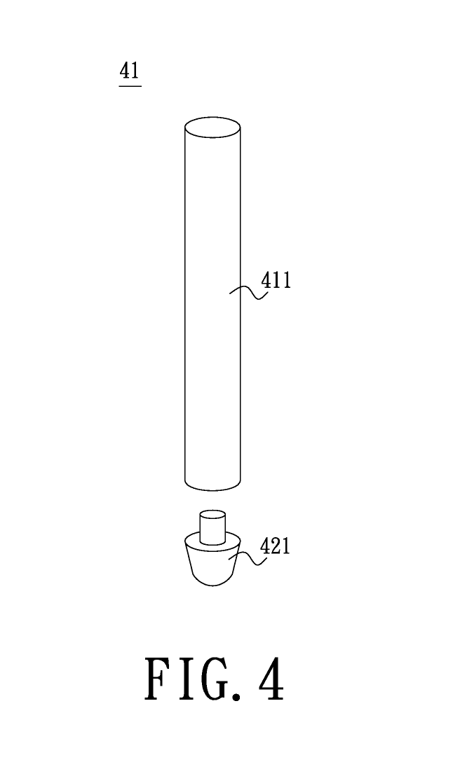

In addition, the input device of a capacitive touchpad of present invention may be used for operating various kinds of touchpads. As shown in the FIG. 4, the input device 4 at least includes a pen body 411 and a replaceable pen nib 421 connecting or setting to one end of the pen body 411. The replaceable pen nib 421 and the pen body 411 are separable for replacement and having an inlaying component in pairs such as a mortising component or a sliding way and related fixing mechanism for insetting into each other.

Again, the replaceable pen nib 421 is made of/from an electric-conductive material for generating an inducing capacitance if the touchpad is a capacitive touchpad. Moreover, the replaceable pen nib 421 may be made of/from a kind of elastic or soft electric-conductive material which is made of/from a polyester compound doped or mixed with a metal powder. The replaceable pen nib 421 may be metallic covering stuffed with the elastic or soft polyester compound in another embodiment for cost management, abrasion resisting, and so on. Furthermore, the pen body 411 and the replaceable pen nib 421 may be made of/from the same, similar or different kind of electric-conductive material, or the replaceable pen nib 421 and the pen body 411 may be made of/from an electric-conductive material and an insulating material respectively.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An input device of a capacitive touchpad, which is capable of generating an inducing capacitance of the capacitive touchpad through holding by a user, comprising:
a pen nib which is made of/from an electric-conductive material for touching the capacitive touchpad;
a pen body with one end connected or set to the pen nib; and
a connect part between the pen nib and the pen body for holding by the user and generating the inducing capacitance with the pen nib.

2. The input device of claim 1, wherein the pen nib, the connect part and the pen body are made of/from the same or similar kind of electric-conductive material.

3. The input device of claim 1, wherein the pen nib and the connect part are made of/from the electric-conductive material different from that of the pen body.

4. The input device of claim 3, wherein the pen nib and the pen body made of/from a first metallic electric-conductive material and an insulating material respectively.

5. The input device of claim 4, wherein the pen nib and the connect part are made of/from the first metallic electric-conductive material.

6. The input device of claim 4, wherein the pen nib is made of/from the first metallic electric-conductive material, and the connect part is made of/from a second metallic electric-conductive material.

7. The input device of claim 1, wherein the connect part is made of/from an insulating material covered with conductive film.

8. The input device of claim 1, the pen nib and the connect part are separable for replacement and having an inlaying component in pairs for insetting into each other.

9. The input device of claim 8, wherein the inlaying component in pairs is a lock component in pairs for the integration and separation of the pen nib and the connect part.

10. The input device of claim 8, wherein the inlaying component in pairs is a mortising component in pairs for the integration and separation of the pen nib and the connect part.

11. The input device of claim 1, wherein a protruding part of the pen nib insets into a concaving part of the connect part.

12. The input device of claim 1, wherein a concaving part of the pen nib insets into a protruding part of the connect part.

13. The input device of claim 12, wherein the protruding part and the concaving part have a spiral in pairs for spiraling to each other.

14. The input device of claim 1, wherein the pen nib is made of/from an elastic or soft electric-conductive material which is made of/from a polyester compound doped or mixed with a metal powder.

15. The input device of claim 14, wherein the pen nib has metallic covering stuffed with the elastic or soft electric-conductive material.

16. An input device for operating a touchpad, comprising:
a pen body for holding by a user; and
a replaceable pen nib which is connected or set to one end of the pen body, wherein the replaceable pen nib is made of/from an electric-conductive material for generating an inducing capacitance if the touchpad is a capacitive touchpad.

17. The input device of claim 16, wherein the replaceable pen nib and the pen body are made of/from the same, similar or different kind of electric-conductive material.

18. The input device of claim 16, wherein the replaceable pen nib and the pen body are made of/from a material different from that of the pen body.

19. The input device of claim 16, wherein the replaceable pen nib and the pen body are separable for replacement and having an inlaying component in pairs for insetting into each other.

20. The input device of claim 16, wherein the replaceable pen nib is made of/from an elastic or soft electric-conductive material which is made of/from a polyester compound doped or mixed with a metal powder.

21. The input device of claim 20, wherein the replaceable pen nib has metallic covering stuffed with the elastic or soft electric-conductive material.
